(19) United States
(12) Patent Application Publication
(10) Pub. No.: US 2004/0132908 A1
(43) Pub. Date: Jul. 8, 2004

(54) Graft copolymers of syndiotactic polystyrene with polar functional group containing grafting arms and processes for their preparations

(76) Inventors: Raymond Chien-Chao Tsiang, Chiayi (TW); Jing-Cherng Tsai, Chiayi (TW); Mu-Ya Chi, Chiayi (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/337,332

(22) Filed: Jan. 7, 2003

(51) Int. Cl. C08F 255/00

(52) U.S. Cl. 525/100; 525/107; 525/123

(57) ABSTRACT

A graft copolymer of a syndiotactic styrene contains polar functional grafting arms. Due to the presence of polar grafting arms, the compatibility of the graft copolymer is substantially improved over the original syndiotactic styrene. Moreover, the graft copolymer can serve as a compatibilizer for a polymer blend so as to improve the compatibility of the polymer blend with other polymers, and increase the impact resistance and elongation of the polymer blend, while the physical properties of the original polymers in the polymer blend can still be maintained.

### BACKGROUND OF THE INVENTION

1. Field of the Invention

The present invention relates to syndiotactic polystyrene (sPS) grafting copolymers, wherein the grafting arms were prepared by grafting copolymerization of the polar-functional groups containing monomers. Thereby, the deficiency (eg, poor adhesion to metal; poor compatibility with other material etc) of the sPS polymer can be improved.

2. Description of Related Art

Syndiotatic polystyrene (sPS) is very useful in many commercial applications. However, it suffers from a major deficiency: poor adhesion to other material (For example, to the copper of PC boards). In addition, sPS has poor compatibility with other functional polymers. Therefore, there is a need to improve the physical properties of the conventional syndiotactic polystyrene.

In order to circumvent the above deficiency in sPS, functional group containing sPS copolymers were prepared by copolymerization of styrene with polar functional group containing vinyl aryl monomers as reported by Zambelli et al (Macromolecules, 1989, 22,104) and Kim et al (Macromolecules 1999, 32, 8703). However, the presence of the polar functional group will significantly reduce the reaction rate for sPS polymerization, by interacting with the cationic active site of the metallocene catalysts, and hence their industrial applications are limited due to their low activity and high production cost. Efforts for introducing polar functional group on the sPS by directly copolymerization with non-aromatic α-olefins were also been disclosed as in U.S. Pat. No. 5,391,671, in which polar monomers of acrylonitrile, methylmethacrylate, methylarylate and n-substituted maleimide were used to undergo the copolymerization with styrene for the preparation of functional group containing sPS material. Similarly, due to the presence of polar functional group, the reported activities for the preparation of these copolymers by metallocene/MAO catalysts were significantly reduced comparing with the homopolymerization of styrene. The other disadvantage of the above approach is that the incorporation of the polar monomers was minimal, and hence the feasibility for industrial application by applying the above method of direct copolymerization of polar functional group is low. Other approach by using the post polymerization reaction methods for the preparation of polar functional group containing sPS has also been reported by Lin et al (Polymer international, 2001, 50,421) and Sen et al (Macromolecular, 2000, 33, 5106). In their studies, sPS polymer was prepared first followed by a tedious and hazardous sulfonation reaction or by a slow atom transfer free radical polymerization (ATRP). Noted that in order to generate the radical initiator for carry out the ATRP polymerization reaction, the sPS polymer need to contain the bromine functional groups, thereby an additional bromination reaction has to be conducted first followed by the ATRP grafting polymerization. Due to the bromination reaction occurred mostly at the benzylic position on the sPS backbone, the reported brominated sPS polymer typically lost their crystallinity (as indicated by lost of melting point) caused by interferring their corresponding syndiotactic stereoregularity of the benzene ring. Obviously, this approach not only requires an extra bromination reaction step but also lead to the reduction the crystalline properties of sPS.

Chung et al in the U.S. Pat. No. 5,543,484 have disclosed a functionalization reaction using α-olefin/para-methylstyrene copolymers as subtract. First, α-olefin and para-methylstyrene were copolymerized. The incorporation of para-methylstyrene into the α-olefin copolymer results in the generation of active benzylic protons, which can be readily deprotonated by treated with strong base (eg. Alkyl lithium), thereby anionic grafting copolymerization can proceed with high efficiency. Using the similar approach for the preparation of polar functional containing grafting sPS polymer was disclosed in this invention.

### SUMMARY OF THE INVENTION

It is an object of the present invention is to solve the above-mentioned problems and to provide a graft copolymer of a syndiotactic styrene, which contains polar functional grafting arms. Due to the presence of polar grafting arms, the compatibility of the graft copolymer of the present invention with other polymers is substantially improved over the original syndiotactic styrene. Moreover, the graft copolymer of the present invention can serve as a compatibilizer for a polymer blend so as to improve the compatibility of the polymer blend with other polymers, and increase the impact resistance and elongation of the polymer blend, while the physical properties of the original polymers in the polymer blend can still be maintained.

To achieve the above-mentioned object, the graft copolymer which containing polar-functional grafting arms of the present invention has the formula of

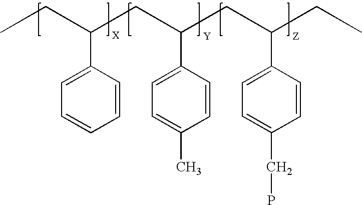

Wherein the distribution of styrene, para-methylstyrene, polar functional grafted para-methylstyrene (X, Y, Z) are in a random distribution.

P is polar functional group containing polymer moiety;

X ranges from 0 to 30000;

Y ranges from 0 to 30000;

Z ranges from 1 to 1000.

### BRIEF DESCRIPTION OF THE DRAWINGS

The above and further objects, features and advantages of the invention will become clear from the following more detailed description when read with reference to the accompanying drawings in which:

FIG. 1 is a ¹H NMR chart of the copolymer contains 10 mole % of polysiloxane in Example 3;

FIG. 2 is a DSC chart of the crystalline melting temperature for both sPS and polyphenylisocyante in Example 5;

FIG. 3 is an IR chart of the amide functional group of sPS in Example 5;

FIG. 4 is a GPC chart of the grafting copolymer after grafting reaction in Example 6; and

FIG. 5 is a GPC chart of the grafting copolymer after grafting reaction in Example 7.

### DETAILED DESCRIPTION OF THE PREFERRED EMBODIMENTS

The structure of polar functional group contacting copolymer of sPS has the formula of:

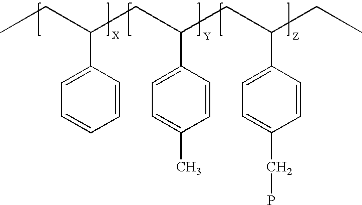

P is polar functional group containing polymer moiety;

X ranges from 0 to 30000;

Y ranges from 0 to 30000; and

Z ranges from 1 to 1000.

Preferably, the copolymer has a number average molecular weight of at least 1000.

The general procedure for preparing the graft copolymer of a syndiotactic styrene/para-alkylstyrene copolymer of the present invention will be described below.

The preparation of the polar functional group containing grafting sPS polymer can be divided into two steps. In the first step, the preparation of syndiotactic styrene/para-methylstyrene random copolymer is conducted by metallocane/MAO catalyst. Because the copolymerization reaction was induced by metallocene catalyst, a coordination polymerization pathway is involved to provide the co-syndiotactic styrene/para-methylstyrene copolymer with random distribution. The preparation of this copolymer has been reported previously by Zambelli et al (Macromelecules, 1989,22,104) and Soga et al (Maromelecules 1990,23,953) and can be illustrated as the following equation:

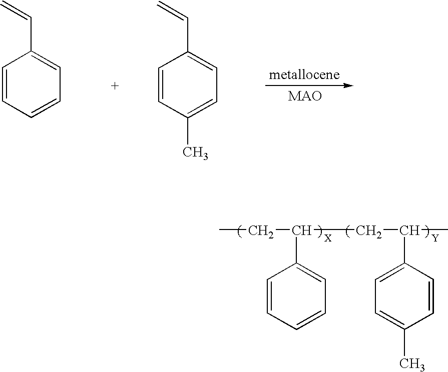

The introduction of para-methylstyrene comonomer into the syndiotatic polystyrene backbone affords the acidic protons on the benzylic methyl position which can be deprotonated by super base at a mild reaction condition as illustrated in following equation:

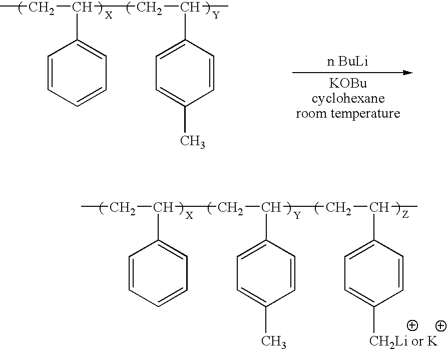

The utilization of super base to undergo the deprotonation reaction at room temperature, results in a selective deprotonation reaction at the benzylic methyl group, and hence providing effective active sites for conducting the anionic grafting polymerization reactions.

The generation of polar functional group containing grafting arms is conducted at certain reaction temperatures by adding specific amount of polar monomers to provide the polar functional group containing grafting copolymer of sPS as shown in the following equation:

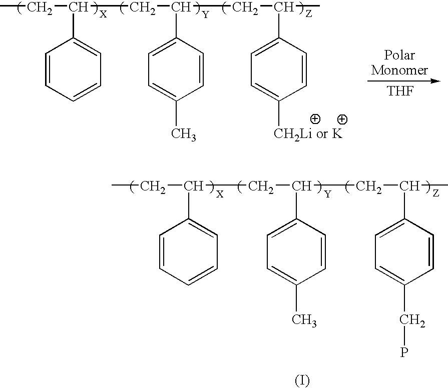

The composition of the polar functional group contain grafting sPS polymer as in structure (I) can has styrene units from 0-3000, paramethylstyrene units from 0-3000, and polar functional group containing grafting units from 1-300.

Representative example of the polymerizable polar monomers includes octamethyl cyclotetrasiloxane, hexamethyl cyclotrisiloxane, 2-vinyl pyridine, 4-vinylpyridine, phenylisocyanate, ethylene oxide and propylene oxide etc.

The general processes for preparing the polar functional group containing sPS grafting copolymer of the present invention will be described below.

The copolymerization of styrene and paramethyl styrene is conducted in the presence of a metallocene catalyst as shown in the following equation:

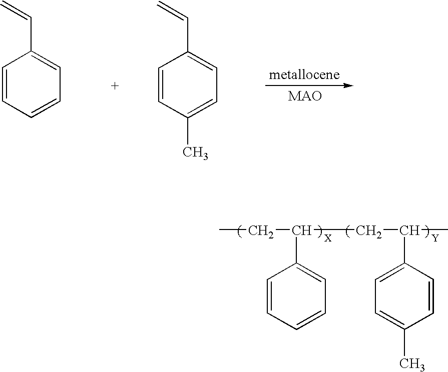

Wherein each x and y is the molar ratio of the respective monomer and x+m=100. The catalyst system may also include an activating cocatalyst such as methyl aluminoxane (MAO). Suitable metallocene catalysts have a delocalized π-bonded ligand such as cyclopentadiene (Cp), indene or fluorene. The catalysts may be further described as a metal coordination complexes comprising a metal of Group IVB-VIB of the Periodic Table of the elements and a delocalized 1-bonded ligand. Some of them have been taught in U.S. Pat. Nos. 4,542,199; 4,530,914; 4,665,047; 4,752,597; 5,026,798; and 5,272,236. Preferred catalyst complexes include Cp-containing and Cp-free titanium coordination compounds.

The activating cocatalyst can be methyl aluminoxane (MAO), a trialkyl aluminum, a dialkyl aluminum, a salt of an inert and non-coordinating anion, or a mixture thereof.

The trialkyl aluminum can be selected from the group consisting of trimethyl aluminum, triethyl aluminum, tripropyl aluminum, trisopropyl aluminum, tributyl aluminum, and triisobutyl aluminum (TIBA).

The inert and non-coordinating anion can be a borate. Borates that are suitable for use in the present invention include N,N-dimethyl anilinium tetrakis (pentafluorophenyl) borate, triphenyl carbenium tetrakis (pentafluorophenyl) borate, triphenyl ammonium tetrakis (pentafluorophenyl) borate, triphenyl ferrocenium tetrakis (pentafluorophenyl) borate, triphenyl dimethyl ferrocenium tetrakis pentafluorophenyl) borate, and silver tetrakis (pentafluorophenyl) borate. Preferable, the activating cocatalyst is methyl aluminoxane, or a mixture of a trialkyl aluminum and a borate.

Suitable diluents for the monomers, catalyst components and polymeric reaction products include the general group of aliphatic and aromatic hydrocarbons, used singly or in a mixture, such as propane, butane, pentane, cyclopentane, hexane, tolune, heptane, isooctane, etc.

In general, the polymerization reaction of the present invention is carried out by mixing styrene and para-methylstyrene in the presence of the catalyst and diluent in a copolymerization reactor, with thorough mixing at a temperature between 0 and 100° C. The polymerization may be carried out in an inert gas atmosphere and in the absence of moisture.

The following equation described the deprotonation reaction by super base for the generation of the anionic reactive sites.

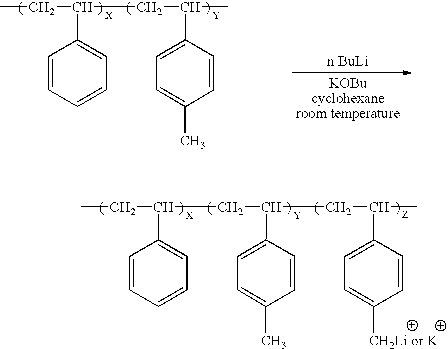

The resulting anionic sites containing copolymer can be used to undergo anionic grafting polymerization reaction as described in the following equation.

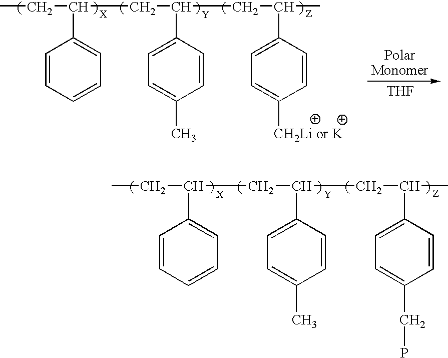

Thereby, the novel sPS-grafting copolymer with polar grafting arms can be prepared as the method described above.

The polar monomers used for the preparation of the desired products are octamethyl cyclotetrasiloxane, hexamethyl cyclotrisiloxane, 2-vinylpyridine, 4-vinylpyridine, phenyl isocyanate, Methylene oxide and propylene oxide.

The following examples are intended to illustrate the process and advantages of the present invention more fully without limiting its scope, since numerous modifications and variations will be apparent to those skilled in the art.

### EXAMPLE 1

### Deprotonation of Syndiotatic Styrene/Para-methylstyrene Copolymer

The syndiotatic styrene/paramethyl styrene copolymers were prepared as the described literature method (Zambelli and Soga). Deprotonation of the copolymers were conducted as the following procedure:

The 20 g of syndiotatic styrene/paramethyl styrene copolymer containing 10 mole % of para-methylstyrene with a crystalline melting point of 243° C. (Mw=160000, PD=2.4) was allowed to suspend in a cyclohxane solution. Then 0.1 mmole of n-Buli and 0.2 mole of potassium tertbutoxide were added. The solution was allowed to react at room temperature for 3 hr to provide the deprotonated polymer as an orange solid. The deprotonated polymer was isolated after filtration, washed with cyclohexane and dried under vacuum. The amount of the deprotonated active sites was determinated by using 0.5 g of the above polymer to react with excess trimethyl silylchloride, providing a silylated copolymer, which contains trimethylsilyl group on each anionic active site. From ¹H NMR analysis the copolymer contains an average of 8 anionic active sites for each polymer.

### EAMPLE 2

### Deprotonation of Syndiotatic Para-methylstyrene Copolymer

The 20 g of syndiotatic paramethyl styrene (Mw=25000, PD=2.2) was allowed to suspend in a cyclohexane solution. Then, 1.2 mmole of n-BuLi and 2.4 mmole of potassium tertbutoxide were added. The solution was allowed to react at room temperature for 3 hr to provide the deprotonated polymer as a brown solid. The deprotonated polymer was isolated after filtration, washed with cyclohexane and dried under vacuum. The amount of the deprotonated active sites was determined by using 0.5 g of the above polymer to react with excess trimethyl silylchloride, providing a silylated copolymer, which contains trimethylsilyl group on each anionic active site. From ¹H NMR analysis the copolymer contains an average of 20 anionic active sites for each polymer.

### EXAMPLE 3

### Preparation of Syndiotatic Poly Para-methylstyrene-graft-polysiloxane (Using Octamethyl Cyclotetrasiloxane as Comonomer)

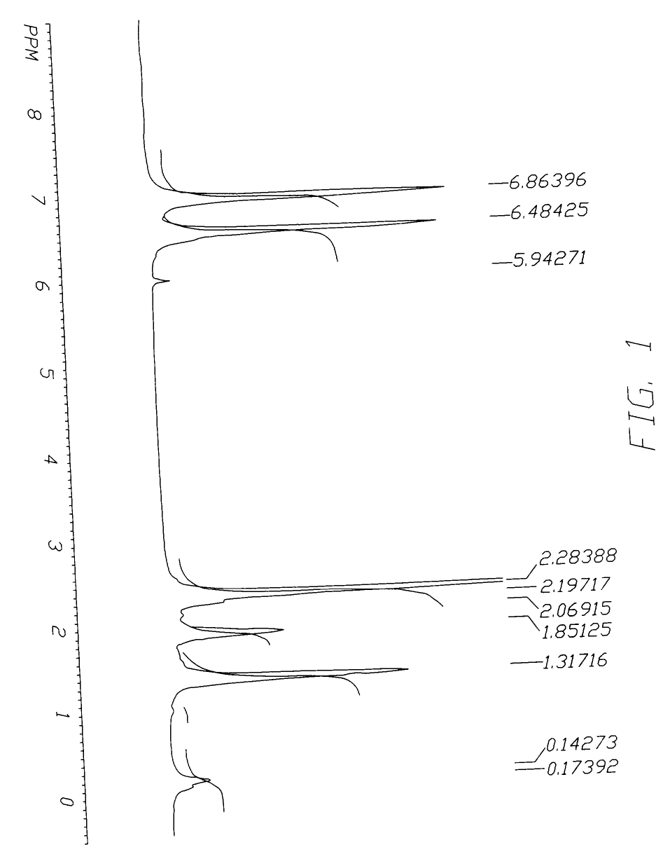

The 1 g of the deprotonated copolymer prepared from example 2 was allowed to suspend in THF and was then treated with 0.5 ml of octamethyl cyclotetrasiloxane monomer at room temperature. The solution was allowed to react at room temperature for 3 days. The resulting solution was then quenched with methanol. The resulting polymer was isolated by filtration and dried under vacuum to give 1.1 g of syndiotatic poly para-methylstyrene-graft-polysiloxane. From ¹H NMR reveal the copolymer contains 10 mole % of polysiloxane (refer to FIG. 1).

### EXAMPLE 4

### Preparation of Syndiotatic Poly Styrene/Para-methylstyrene-graft-polysiloxane (Using Hexamethyl Cyclotetrasiloxane Monomer)

The 1 g of the deprotonated copolymer prepared from example 1 was allowed to suspend in THF and was then treated with 0.5 ml of hexamethyl cyclotetrasiloxane monomer at room temperature. The solution was allowed to react at room temperature for 3 days. The resulting solution was then quenched with methanol. The resulting polymer was isolated by filtration and dried under vacuum to give 1.3 g of syndiotactic polystyrene/para-methylstyrene-graft-polysiloxane.

### EXAMPLE 5

### Preparation of Syndiotatic Poly Styrene/Para-methyl styrene-graft-polyphenylisocyanate

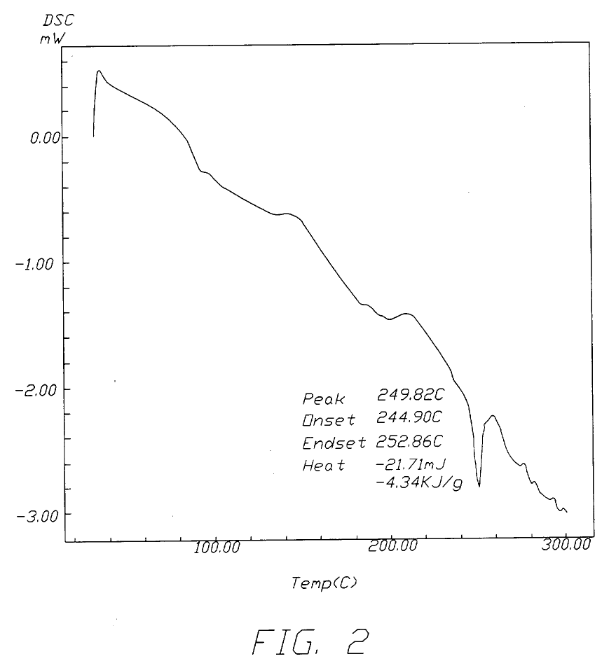

The 1 g of the deprotonated polymer prepared from example 1, was allowed to suspend in THF and was then treated with 0.5 ml of phenylisocyante. The solution was allowed to stir at room temperature for 6 hr and was then quenched with methanol. The polymer was isolated from filtration and dried at 70° C. in a vacuum oven overnight to give 1.25 g of syndiotatic poly styrene/para-methylstyrene-graft-polyphenylisocyanate. Thermal analysis by DSC indicates the polymer contains two crystalline melting temperatures (refer to FIG. 2) corresponding to the crystalline melting temperature for both sPS and polyphenylisocyante.

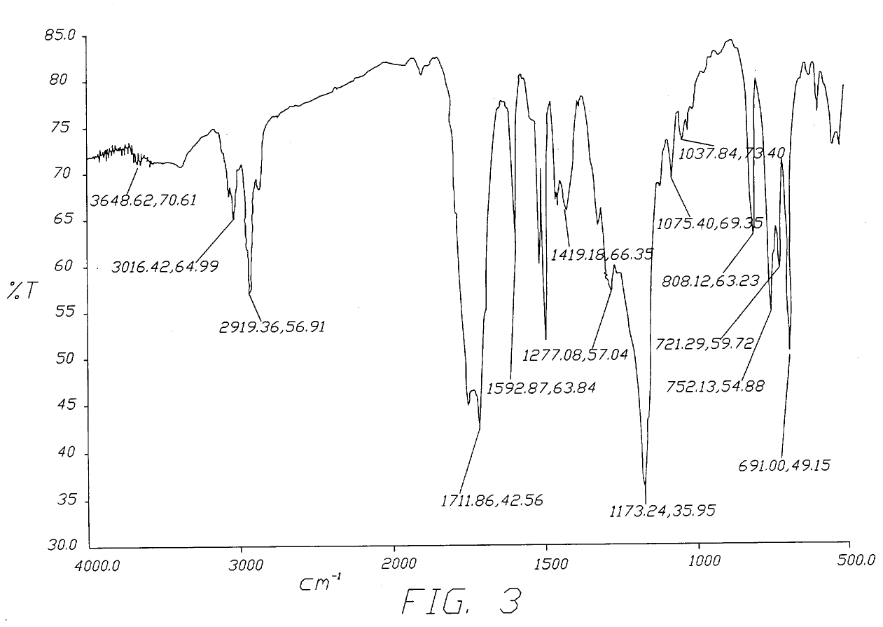

The IR analysis clearly reveals the presence of the CO absorption of the amide functional group derived from isocyante at 1711˜1720 cm⁻¹ (refer to FIG. 3).

### EXAMPLE 6

### Preparation of Syndiotatic Poly Para-methylstyrene-graft-2-vinylpyridine

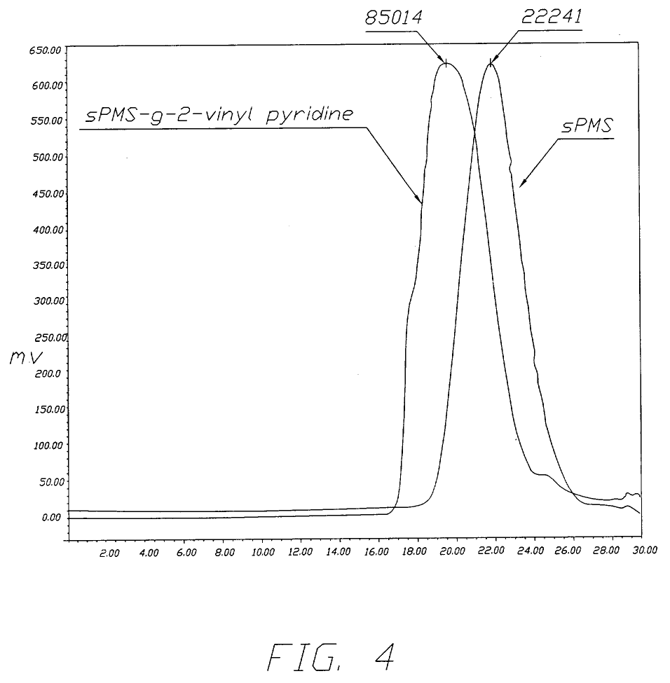

The 1 g of the deprotonated polymer prepared from example 2, was allowed to suspend in THF. The resulting solution was allowed to cool to −80° C. and was then added with 5 ml of 2-vinyl pyridine. The solution was allowed to stir at −80° C. for 2 days to give a red solution. The syndiotatic poly paramethylstyrene/styrene-graft-2-vinyl pyridine was isolated after filtration, purified by soxlet extraction with methyl ethyl ketone and dried at 70° C. under vacuum overnight to give 3.2 g of polymer. GPC analysis reveals that the molecular weight of the original polymer (Mw=22,000) has substantially increased after the grafting reaction. Thereby, the grafting copolymer with Mw=102262 was produced after the grafting reaction (refer to FIG. 4).

### EXAMPLE 7

### Preparation of Syndiotatic Poly Para-methylstyrene graft-4-vinylpyridine:

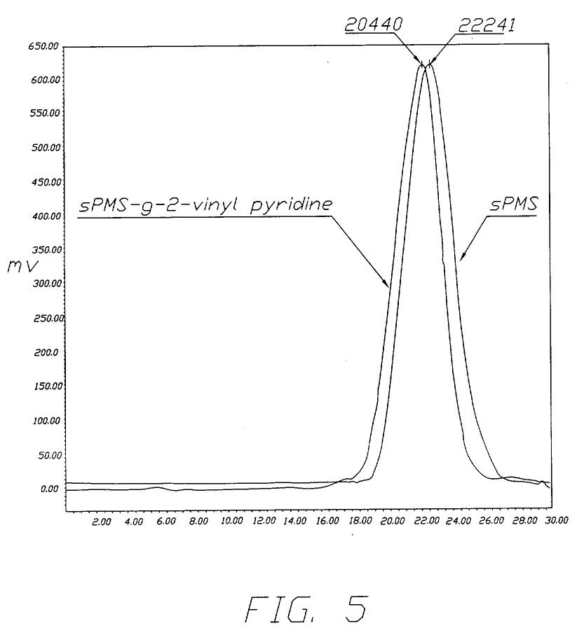

The 1 g of deprotonated polymer prepared from example 2, was allowed to suspend in THF. The resulting solution was allowed to react with 1,1 diphenyl ethylene at room temperature for 1 hr. Then the solution was cooled to −80° C. and was added with 0.5 ml of 4-vinylpyridine. The solution was allowed to stir at −80° C. for 2 days to give an orange solution. The syndiotatic poly para-methylstyrene-graft-4-vinylpyridine was isolated after filtration and purified by soxlet extraction with methyl ethyl ketone and dried at 70° C. under vacuum overnight to give 1.4 g of polymer. GPC analysis reveals that the molecular weight of the original polymer (Mw=22,000) has substantially increased after the grafting reaction. Thereby, the grafting copolymer with Mw=39017 was produced after the grafting reaction (refer to FIG. 5)

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A graft copolymer containing polar-functional containing grafting arms having the formula of: 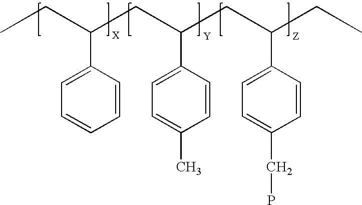
Wherein the distribution of styrene, para-methylstyrene, polar functional grafted para-methyl styrene (as in X, Y, Z) are in a random distribution, and P is polar functional group containing polymer moiety; X ranges from 0 to 30000; Y ranges from 0 to 30000; and Z ranges from 1 to 1000.

2. The graft copolymer as claimed in claim 1, wherein the P is a polysiloxane grafting arm; P=—[—Si(R)₂—O—]— wherein R is a C₁-C₁₂ alky or aryl hydrocarbons.

3. The graft copolymer as claimed in claim 1 wherein the P is a poly isocyanate grafting arm; P=—[—CO—NR—]— wherein R is a C₁-C₁₂ alky or aryl hydrocarbons.

4. The graft copolymer as claimed in claim 1, wherein the P is a poly-2-vinylpyridine grafting arm; P=—[—CH₂CH—C₅H₄N—]— wherein the structure of pyridinyl nitrogen atom is at 2-position.

5. The graft copolymer as claimed in claim 1, wherein the P is a poly-4-vinylpyridine grafting arm; P=—[—CH₂CH—C₅H₄N—]— wherein the structure of pyridinyl nitrogen atom is at 4-position.

6. The graft copolymer as claimed in claim 1, wherein the P is a polyethylene oxide grafting arm; P=—[—CH₂CH₂—O—]—.

7. The graft copolymer as claimed in claim 1, wherein the P is a polypropylene oxide grafting arm; P=—[—CH₂CHCH₃—O—]—.

8. The graft copolymer as claimed in claim 1, wherein the P is prepared from coupling reaction to macromers, which contains polar functional group.

9. A process for the preparation of the syndiotactic polystyrene-graft-polar-functional group containing copolymers is conducted by the initial deprotonation reaction followed by an anionic grafting reaction.

10. The process as claimed in claim 9, wherein the process involves using normal butyl lithium, secondary butyl lithium or teriary butyl lithium as the deprotonation reagent.

11. The process as claimed in claim 9, wherein the process involves using normal butyl lithium, secondary butyl lithium or teriary butyl lithium and in the presence of TMEDA as the deprotonation reagent.

12. The process as claimed in claim 9, wherein the process involves using normal butyl lithium, secondary butyl lithium or teriary butyl lithium and in the presence of potassium alkoxide as the deprotonation reagent.

13. The process as claimed in claim 9, wherein the process is conducted in diluents or in the bulk polar monomers.
